(19) United States
(12) Patent Application Publication
(10) Pub. No.: US 2004/0145576 A1
(43) Pub. Date: Jul. 29, 2004

(54) Wearable touch pad device

(76) Inventor: Eduard Gerhard Zondag, Eindhoven (NL)

Correspondence Address: Corporate Patent Counsel, Philips Electronics North America Corporation, P O Box 3001, Briarcliff Manor, NY, 10510, US

(21) Appl. No.: 10/475,886

(22) PCT Filed: Apr. 22, 2002
(86) PCT No.: PCT/IB02/01503

(30) Foreign Application Priority Data
Apr. 26, 2001 (EP) 01201523.6

(51) Int. Cl. G09G 5/00

(52) U.S. Cl. 345/173

(57) ABSTRACT

A touch pad device (1) comprising one or more touch sensitive areas (2) provided on at least one side of the housing for allowing a user to touch a certain part of the areas to input desired information, control electronics (52) connected to the touch sensitive areas (2), provided in the interior of the housing and for output of a control signal for interpreting the desired information, and a signal transmitter (15, 53) connected to the control electronics for transmitting the control signal to the outside of a touch pad device e.g. for controlling an apparatus such as household appliances, and/or audio video apparatuses.

The present invention relates to remote control devices. Equipment, such as lights, household appliances, audio and video equipment and/or computers and the like can be controlled using a remote control device. Conventionally, for every apparatus a dedicated remote control device is supplied. Therefore people have a growing number of remote control devices in their homes which can easily get lost.

To reduce this problem, remote control devices have been developed that combine the functions of operating a number of apparatuses. These combined devices usually have a large number of buttons which increase dimensions of such remote controls.

The present invention provides a touch pad device, comprising:

a housing;

one or more touch sensitive areas provided on at least one side of the housing for allowing a user to touch a certain part of the areas to input desired information;

control electronics connected to the touch sensitive areas, provided in the interior of the housing and for output of a control signal for interpreting the desired information; and

a signal transmitter connected to the control electronics for transmitting the control signal to the outside of a touch pad device e.g. for controlling an apparatus such as household appliances, and/or audio video apparatuses;

A controlling device according to the present invention can be easily taken along for controlling a multitude of devices in a multitude of environments.

A preferred embodiment of the invention has the characteristic that the transmitter is a wireless transmitter so that it can be taken along more easily.

In a living room turning on of the television, changing the volume or channel thereof, and/or dimming the light after turning on the television, could be done with the same device. The same device would also be capable of controlling some devices and/or lights in another room.

Another preferred embodiment of the invention is that the device comprises additional input means for varying the sensitivity of the touch sensitive area according to wishes of the user of the device.

In another preferred embodiment the housing comprises attaching means whereby it becomes possible to attach the device to clothing at a preferable position and to operate the device starting from the position where it is attached. The device can also be used on several kinds of garments consecutively.

It is preferable that the used signals are infrared signals, as infrared signals have the advantage that they stop if a line of vision is interrupted. This can be preferable if more than one device are used at close range e.g. in one household. Chances of interference between two or more devices will be small. However, in other cases it can be advantageous that signals cannot be stopped by an obstacle. In such cases radio waves can be applied. If the control device is attached to the body, the transmitter is preferably direction-insensitive because clothing lets radio waves pass through.

A further preferred embodiment of the invention provides that the control function changes dependent on the position of the touch on the sensitive area. This is especially advantageous because this way it is possible to emulate a multitude of sliding switches with one touch sensitive area. For instance, fine adjustments to the brightness of the light in a room can be made using the left side of the touch sensitive area and one could make sudden big variations of the brightness of the light in a room using the right side of the touch sensitive area.

Furthermore, the device can be equipped with receiving means for e.g. receiving management information for the device which can be done remotely on e.g. a platform with sufficient resources like a computer.

A further aspect of one embodiment is that the device can be turned on or off by tapping on the touch sensitive area or on a specific part of the touch sensitive area.

Another preferred embodiment of the invention comprises indicator means for allowing a user to know which side of the touch sensitive area is a more sensitive side than the other side. This aspect can be embodied by ridges that vary in thickness along the touch sensitive area.

Further advantages, features and details of the present invention will be illustrated on the basis of the following description of preferred embodiments thereof with references to the annexed drawings, in which:

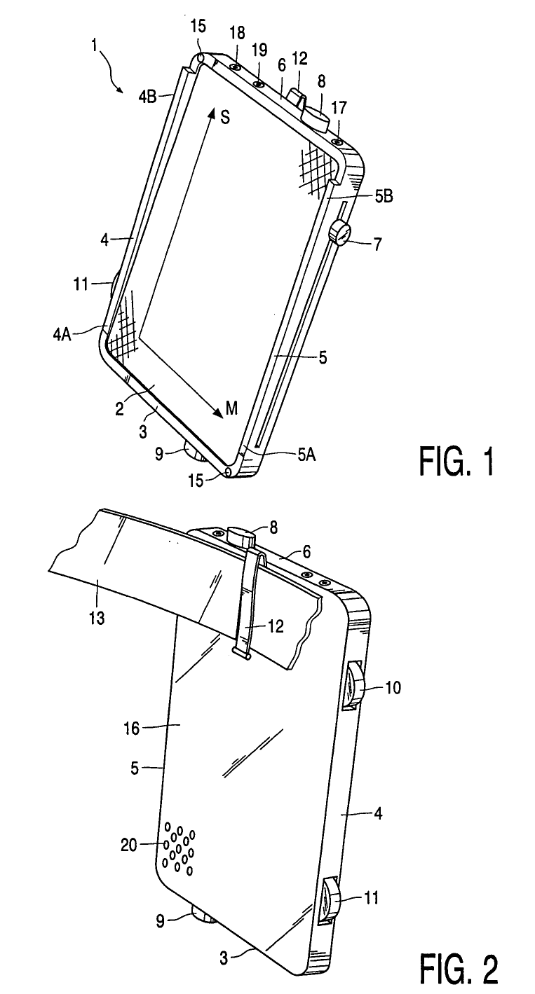

FIG. 1 shows a perspective view of a first preferred embodiment of a device according to the present invention;

FIG. 2 shows a perspective view of the embodiment of FIG. 1 from the other side;

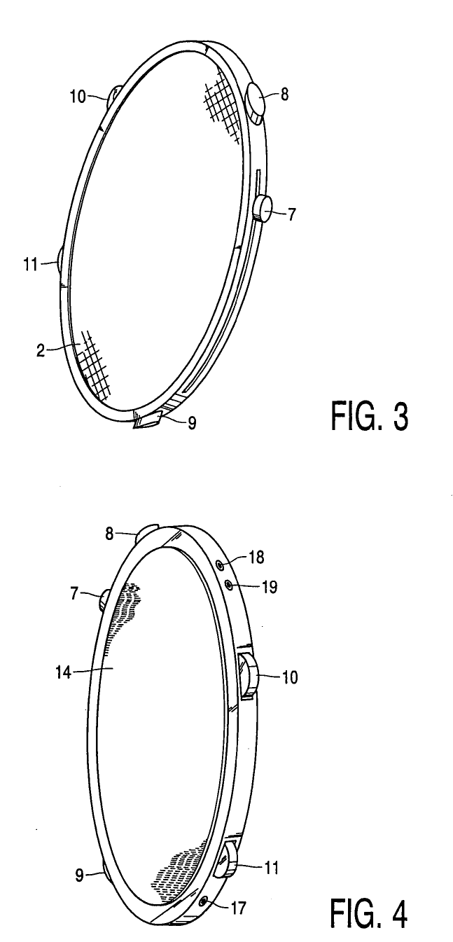

FIG. 3 shows a perspective view of another preferred embodiment of a device according to the present invention;

FIG. 4 shows a perspective view of the embodiment of FIG. 3 from the other side;

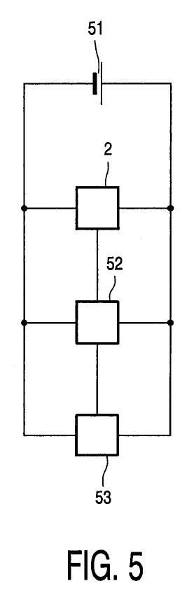

FIG. 5 is a block diagram of an embodiment of the invention;

A first preferred embodiment of a device (FIG. 1) according to the present invention comprises a housing comprising four sidewalls 3,4,5 and 6, a top wall comprising a touch sensitive touch pad 2 and a bottom wall 16 comprising a clip 12 for attaching the device 2 to some kind of clothing or the like 13.

Furthermore, these sidewalls 4 and 5 are equipped with ridges that are low at the left end and high at the right end. Two infrared emitters 15 are positioned at diagonally opposed corners in the top wall. Sidewall 5 is equipped with a sliding switch 7. Sidewall 6 is equipped with a microphone 18, an audio out connector 19, a control data connector 17 and a push button 8. Sidewall 4 is equipped with two turning switches 10, 11 and sidewall 3 is equipped with push button 9. The bottom wall 16 is equipped with loudspeaker holes 20 for enabling the sound of a loudspeaker to pass through.

The embodiment of the FIGS. 3 and 4 has a different shape than the embodiment of the FIGS. 1 and 2 the same reference numerals referring to similar parts are used as much as possible in FIGS. 3 and 4.

The infrared transmitters 15 are used for sending data from the control electronics to devices that are being controlled by using the touch pad. Control data can be sent from the touch pad device by means of radio transmission for which an antenna (not shown) can be built in- or outside the device. Another way of transmitting control signals to other devices is through wires. For this purpose a connector 17 is provided at the side 6 of the touch pad device.

Furthermore, the touch pad is equipped with a microphone 18, a loudspeaker 20 and an audio out connector 19. Audio, such as voice, is another way of data input that can be used for controlling devices.

A touch pad device of such dimensions, in a range preferably from 3.5 cm×5.0 cm to e.g. 6.0 cm×12.0 cm, is very suitable for use on clothing. This embodiment is therefore equipped with a clip 12 for detachably attaching it to clothing 13. Another preferred embodiment (FIG. 4) is equipped with velcro 14 for detachably attaching the device to clothing. An advantage of attaching a device like this on clothing is that it is always ready for use.

By touching and/or sliding a finger or an object such as a marking pen or a stylus on the surface of the touch pad, data is entered into the touch pad. Control electronics transform this touch pad data into output signals. One aspect of this embodiment is that the sensitivity of a movement along the touch pad is varied depending on the location of said movement.

Other types of data entry into the touch pad device can be done by using switches 7,8,9,10 and 11. Such switches can be of different types such as push switches 8, 9, sliding switches 7, and turning switches 10, 11. These switches can be used for additional functionality, e.g. the degree of the sensitivity of the touch pad, controlling of a device that is being controlled using the touch pad, scrolling through a list on e.g. a TV or a computer screen, or function selection.

The sensitivity can also vary depending on the location of the touch on the touch pad. In FIG. 1, arrows are shown with the markings M and S. These markings represent sensitivity and movement. If a user wishes to vary the volume of a audio set using the functionality of the touch pad, a finger can be slided in the direction of arrow M. If a finger is moved along the M direction on the upper side of the touch pad, a short movement effects a large variation in volume, while the same movement on the lower side of the touch pad effects a small variation in volume. It is therefore easier to make quick, sudden variations in volume on the upper side of the touch pad while it is easier to make fine adjustments on the lower side of the touch pad.

The embodiment of FIG. 1 is further provided with two ridges parallel to sides 4, 5 of the device opposite to each other alongside the touch pad, which are thin at one end 4A, 5A and are thicker at the other end 4B, 5B. This enables a user of the device to sense, without having to look at the device, at which end a movement along arrow M will be more or less sensitive.

Similarly, movement of a finger or stylus along the S direction is interrupted dependent on the position on the area 2 at which said movement was made. The ridges 4, 5 again serve to help a user to sense at which end the movement will be more or less sensitive.

The touch pad device (FIG. 5) is powered by a battery 51 that is connected to the touch sensitive area 2, the control electronics 52 and the transmitter 53. When a finger is moved on the surface of the touch sensitive area 2 touch data is generated by the touch sensitive area. This touch data is sent to the control electronics 52 for interpretation thereof. Furthermore, the control electronics use the touch data for generating a transmission signal that is transmitted by transmitter 53. This transmission signal is suitable for controlling devices as described in the above.

To preserve battery power, the device 1 is preferably arranged to automatically deactivate itself after it has not been used for a predetermined amount of time. This amount may be configurable by the user. Such a time-out function reduces the need to replace or rechange the battery 51.

The present invention is not limited to the above description of preferred embodiments thereof, the rights applied for are defined in the annexed claims, within the scope of which many variations are possible.

1. A touch pad device (1), comprising:
a housing;
one or more touch sensitive areas (2) provided on at least one side of the housing for allowing a user to touch a certain part of the areas to input desired information;
control electronics (52) connected to the touch sensitive areas (2), provided in the interior of the housing and for output of a control signal for interpreting the desired information; and
a signal transmitter (15, 53) connected to the control electronics for transmitting the control signal to the outside of a touch pad device e.g. for controlling an apparatus such as household appliances, and/or audio video apparatuses;

2. The device of claim 1, wherein the signal transmitter (53) is a wireless transmitter (15).

3. The device according to claim 1, further comprising additional input means (7) for varying the sensitivity of the touch sensitive area (2) according to input from the user.

4. The device according to claim 1, wherein the housing comprises attaching means (12,14) for attaching/detaching the device to and from clothing.

5. The device according to claim 1, wherein the control changes dependent on the position of the touch on the touch sensitive area (2).

6. The device according to claim 1, further comprising receiving means (15) for receiving management information for the device.

7. The device according to claim 1, are arranged to be activated or de-activated by tapping on the touch sensitive area (2).

8. A device according to claim 1 equipped with indicator means (4, 5) for indicating which side of the touch sensitive area is sensitive and which side is less sensitive.

9. Apparatus and/or clothing provided with a device according to any of the preceding claims.
